(19) United States
(12) Patent Application Publication
(10) Pub. No.: US 2024/0344536 A1
(43) Pub. Date: Oct. 17, 2024

(54) HYDRAULIC STABILIZATION DEVICE

(71) Applicant: Van Halteren Technologies Boxtel B.V., RS Boxtel (NL)

(72) Inventor: Dirk LEPELAARS, RS Boxtel (NL)

(21) Appl. No.: 18/702,277

(22) PCT Filed: Nov. 4, 2022
(86) PCT No.: PCT/EP2022/080780

§ 371 Date: Apr. 17, 2024

(30) Foreign Application Priority Data
Nov. 5, 2021 (DE) 102021212457.7

(51) Int. Cl. F15B 15/14; F15B 21/14

(52) U.S. Cl. CPC F15B 15/1447; F15B 21/14; F15B 2211/20515; F15B 2211/20546

(57) ABSTRACT

The present disclosure relates to a hydraulic stabilization device for stabilizing a load, which is suspended from a base on a defined height relative to a horizontal reference plane, the base having a variable height relative to the horizontal reference plane, the hydraulic stabilization device including a cylinder piston unit connected or connectable in a force transmission path between the base and the load and comprising a piston, which separates two pressure chambers having different piston pressure applying surfaces and acting in opposing directions with respect to each other, and a hydraulic pressure storage device.

The present disclosure relates to a hydraulic stabilization device according to the preamble of claim 1.

Sea motion or swell compensation devices (heave compensation systems) are used, for example, in offshore/marine technology for stabilizing a load which is lowered or deposited on a seabed or a fixed platform by means of a floating crane or base. To compensate for relative motions caused by swell or relative movements of the crane or base relative to the load, passive compensation systems and active compensation systems are known. Simple passive compensation are usually adapted to one specific load and application, whereas active compensation systems provide particularly accurate load guidance and often need complex cables and reeving systems. In some combined solutions, a complex four-chamber accumulator is connected to active and passive sides of a cylinder piston unit.

Prior art be found e.g. in EP 3 290 383 A1, which discloses a sea state compensation device, wherein a load is suspended via a complex suspension system including a passive compensation unit and an active compensation unit, which are designed as linear actuators that are coupled mechanically with each other. In the passive compensation unit, a first piston is supported by fluid pressure applied to one cylinder chamber via a gas spring, and an opposing cylinder chamber is e.g. connected to a working fluid balancing device. In the active compensation unit, working fluid is pumped between two opposing cylinder chambers.

The object underlying the present disclosure is to provide a hydraulic stabilization device for stabilizing a load suspended from a base that will reduce or eliminate problems of the prior art. In particular, a hydraulic stabilization device should be provided, which is cost-efficient and simple.

This object is achieved by a hydraulic stabilization device defined in claim 1.

Further advantageous embodiments are described in the subclaims.

In detail, the hydraulic stabilization device (also called a heave compensation system) is provided for stabilizing a load, which is suspended from a base on a defined height relative to a horizontal reference plane, the base having a variable height relative to the horizontal reference plane. In particular, the horizontal reference plane is fixed and horizontal with respect to the earth or fixed environmental surroundings, e.g. the ocean floor beneath the base. The defined height may be a fixedly set height for holding the load or a variable height for lowering and lifting the load. The hydraulic stabilization device includes a cylinder piston unit connected or connectable in a force transmission path between the base and the load. The cylinder piston unit is not restricted to a round cylinder shape and may have any appropriate cross-sectional shape. Further, the hydraulic stabilization device comprises a piston, which separates two pressure chambers having different (effective) piston pressure applying surfaces and acting in opposing directions with respect to each other. A short circuiting line is adapted to selectively fluidically connect the two pressure chambers. Two elements being fluidically connected in the context of the present disclosure means that fluid may flow between said two elements. Additionally, the hydraulic stabilization device comprises a hydraulic pressure storage device, which is, in particular directly or indirectly, fluidically connected to the short circuiting line, in order to extend and retract the cylinder piston unit in response to a dynamic height variance of the base and in an opposite direction of said dynamic height variance of the base, by providing a dynamic pressure equilibrium between the two pressure chambers.

This makes it possible to provide a system for passive compensation which is particularly simply structured and provides a spring and dampening effect for stabilizing the load. In particular, when the base moves relative to the load, the hydraulic compensation device controls working fluid flow between the pressure chambers and the hydraulic pressure storage device to provide the dynamic pressure equilibrium. The hydraulic pressure storage device is in particular a known hydraulic accumulator. No difficult parts such as a complex four-chamber accumulator and no large number of cables and reeving are needed. Also, in this hydraulic stabilization device, the load is suspended from a hanging cylinder piston unit, which may therefore be loaded in a pulling fashion and the load may extend the cylinder.

Advantageously, the hydraulic stabilization device further comprises a hydraulic displacement machine, particularly a hydraulic fixed-displacement machine or two-way pump, e.g. a sytronix pump by Bosch Rexroth, being fluidically connected to at least one of the two pressure chambers and being adapted to supply a working fluid thereto. This makes it possible to provide both active compensation and passive compensation via the cylinder piston unit, providing a particularly simple and slim structure. In particular, the load may be connected centrally to or in alignment with the cylinder piston unit, which advantageously achieves direct and linear force transmission. That is, the hydraulic stabilization device preferably has a single cylinder housing guiding a single piston. Advantageously, a load side of the cylinder piston unit may be overcompensated since it is loaded via both the load and a pressure applied via a base-side of the cylinder piston unit, in order to be able to both push and pull with only one active side of the cylinder piston unit, particularly a three chamber cylinder piston unit.

Preferably, the hydraulic displacement machine is, on another side, connected to the hydraulic pressure storage device, the hydraulic displacement machine being in particular arranged parallel to the short circuiting line. Due to this, a pressure difference to be overcome by the hydraulic displacement device is reduced or even zero, when the short circuiting line has been open before the hydraulic displacement device is driven. Thus, energy usage is low and reaction time of the hydraulic displacement device are optimized. Additionally, the hydraulic pressure storage device (i.e. the passive side of the cylinder piston unit and hydraulic circuitry) may serve as a reservoir for working fluid—e.g. hydraulic oil—for feeding the hydraulic displacement machine. Thus, an additional reservoir for the working fluid may be omitted and the present hydraulic stabilization device is further simplified.

The hydraulic stabilization device may have a passive (load-side) hydraulic circuitry connecting the load-side pressure chamber and the hydraulic pressure storage device with the short circuiting line and optionally with the hydraulic displacement device. Further, the hydraulic stabilization device may have an active (base-side) hydraulic circuitry connecting the base-side pressure chamber with the short circuiting line and optionally with the hydraulic displacement device.

It is particularly advantageous if the hydraulic stabilization device further comprises a control unit adapted to control the hydraulic displacement machine and the short circuiting line such that, in a passive compensation mode, the short circuiting line fluidically connects the two pressure chambers, or in an active compensation mode, the short circuiting line fluidically disconnects the two pressure chambers and the hydraulic displacement machine is active. Therefore, a switch-over from active to passive compensation can be achieved simply and quickly.

According to a preferred embodiment, the control unit controls an electric motor driving the hydraulic displacement machine. Preferably, the electric motor and the control unit, and optionally a corresponding power grid, are suitable for energy regeneration. Thus, since most of the energy can be regenerated in the electric drives, or in the electric motor and in the control unit, energy usage is minimized.

Alternatively, according to another preferred embodiment, the control unit controls at least one—in particular several—secondary hydraulic drive(s) driving the hydraulic displacement machine. Preferably the at least one secondary hydraulic drive is adapted to receive and restore hydraulic power from, or respectively to, a passive working fluid volume, e.g. the hydraulic pressure storage device. A boost unit may be provided, boosting a pressure of or applied to the passive working fluid. Such a boost unit advantageously can cope/balance losses of pressure in the working fluid.

The electric motor or the at least one secondary hydraulic drive may be a driving unit for driving the hydraulic displacement machine with variable speed and/or torque. Thus, the stabilization device may stabilize the load particularly accurate.

Moreover, the two pressure chambers preferably include a load-side pressure chamber, which is arranged on a side of the piston facing towards the load and includes one of the piston pressure applying surfaces providing a load-side piston pressure applying surface. Further, the two pressure chambers may include a base-side pressure chamber, which is arranged on a side of the piston facing towards the base and includes another one of the piston pressure applying surfaces providing a base-side piston pressure applying surface. In particular, the load-side piston pressure applying surface is larger than the base-side piston pressure applying surface. Due to this, the working fluid volume in the load-side chamber may support the load and the hydraulic pressure storage device may act as a compressive gas spring. The load may be connected to the piston, i.e. on a rod side of the cylinder piston unit, and the base may be connected to a cylinder housing, i.e. a bottom side of the cylinder piston unit. In this case, passive compensation may be provided via a rod-side compartment, which is in particular the load-side pressure chamber.

Preferably, a (initial/static equilibrium/basic) pressure of the hydraulic pressure storage device is provided in accordance with the load and a ratio of the piston pressure applying surfaces with respect to each other. In particular, the (initial/static equilibrium/basic) pressure of the hydraulic pressure storage device is a pressure, which is achieved when the load is statically supported in the passive compensation mode, i.e. when the base is static. This allows to adapt the hydraulic stabilization device according to a specific load, preferably such that the cylinder piston unit is extended halfway in a pressure equilibrium. For example, this ratio can be between 4:1 to 6:1, preferably even higher (10:1 for energy efficiency). The limit on the ratio is the total amount of force that can be generated from the base-side pressure chamber. Said ratio preferably is a ratio of the rod side versus bottom side, i.e. a ratio of the load-side piston pressure applying surface with respect to the base-side piston pressure applying surface. Preferably, the (initial/static equilibrium/basic) pressure is adjusted so that an equilibrium is reached at half of a total pressure capacity of the hydraulic stabilization device as a whole, or in other words, when a pressure of the base-side pressure chamber pushing towards the load-side pressure chamber is at half said capacity.

In particular, surface areas of opposing inner surfaces of the base-side pressure chamber, which respectively face towards and away from the load, are different from each other. These surface areas may be subtracted from each other to define an effective base-side surface, i.e. the (effective) base-side piston pressure applying surface. Similarly, the (effective) load-side piston pressure supplying surface may be an effective load-side surface defined by subtracting surface areas of inner surfaces of the load-side pressure chamber, which respectively face towards and away from the load.

It is particularly advantageous if the piston includes a hollow piston rod accommodating one of the two pressure chambers, particularly providing a bottom side compartment. This way, it is possible to achieve a large ratio of the piston pressure applying surfaces while providing a cylinder piston unit having a slim and low-weight built. If the ratio is large, a high load can be compensated without increasing the (initial/static equilibrium/basic) pressure of the hydraulic pressure storage device. In particular, the active compensation is provided via the bottom side compartment, which is in particular the base-side pressure chamber. A third chamber may be formed surrounding the bottom side compartment. Said third chamber may be filled with a low-pressure gas, particularly nitrogen, and thus be essentially unused for compensation. Said third chamber may protect the cylinder piston unit from corrosion.

Further preferably, the short circuiting line includes a flow control device, preferably a control valve, adapted to selectively open or restrict, particularly prevent, a flow of the working fluid through the short circuiting line. This is a particularly cost-efficient and simply controllable option.

In other words, the hydraulic stabilization device according to the present disclosure may have a cylinder piston unit with a piston rod connected to a load, a cylinder housing connected to a movable base, a passive rod-side compartment (i.e. load-side pressure chamber) and an active bottom-side compartment (i.e. base-side pressure chamber). The passive rod side of the cylinder piston unit may be overcompensated in order to be able to both extend and retract the cylinder piston unit (push and pull) with only one active side (bottom side) of the cylinder piston unit. In principle, the bottom side compartment can only effectively extend the cylinder piston unit/push it out, and the retracting/pulling is achieved by a rod-side pressure in the rod-side compartment. I.e. lowering a bottom side pressure in the bottom-side compartment will retract the cylinder piston unit and increasing the bottom side pressure will extend the cylinder piston unit. In addition, the bottom side compartment may be connected to the rod side compartment. This can either be done with a short circuiting line including a large valve (flow control device) to obtain a passive system wherein the cylinder piston unit can move in and out. The pressure of a gas volume in the hydraulic accumulator (hydraulic pressure storage device) will increase when the cylinder moves out and decrease when it moves in. A spring like behavior may be obtained in this way. Another way of connecting the bottom and rod side compartments is via a pump (hydraulic displacement machine). This pump can actively pump oil (working fluid) to and from the bottom side compartment, effectively controlling the cylinder position. This is an active compensation mode. The spring like behavior of the gas volume is still active in this case.

The present disclosure may relate to a system including a crane serving as the base, particularly with the hydraulic stabilization device provided in a crane hook.

Preferred embodiments are illustrated in the figures.

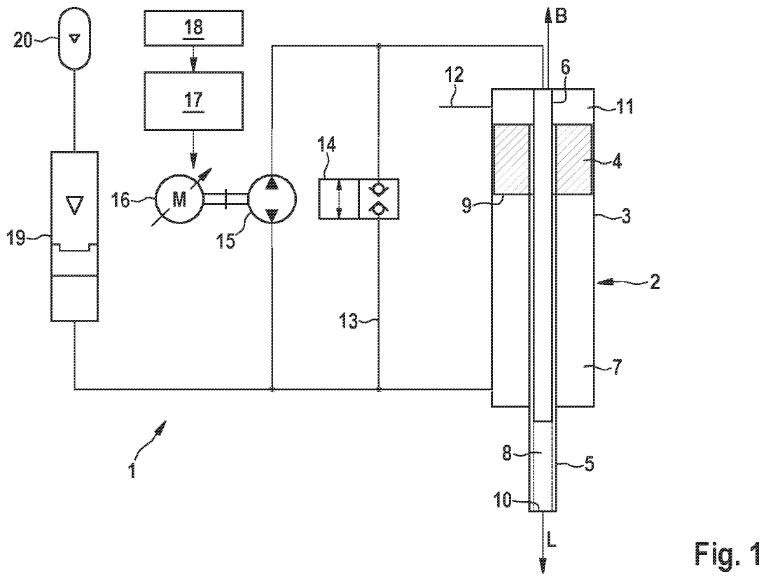

FIG. 1 shows a schematic diagram of a hydraulic stabilization device according to a first embodiment.

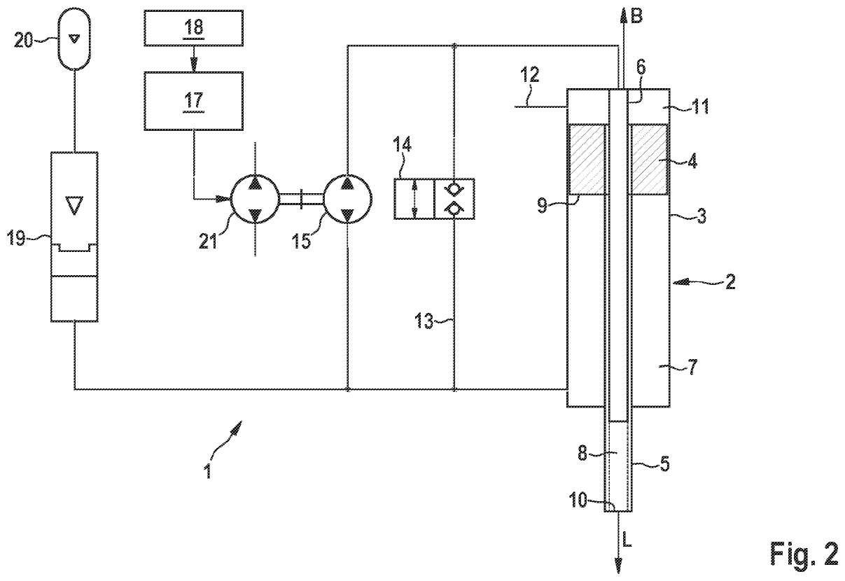

FIG. 2 shows a schematic diagram of a hydraulic stabilization device according to a second embodiment.

FIG. 1 shows the first embodiment of the hydraulic stabilization device 1 according to the present disclosure. The hydraulic stabilization device 1 is provided for compensation of motion of the sea or swell for offshore applications. In particular, the hydraulic stabilization device 1 is provided for compensating a motion of a base B such as a floating crane, which is subjected to the motion of the sea, and a load L, which is suspended from said base B and is being stabilized on a defined height by the hydraulic stabilization device 1. The hydraulic stabilization device 1 comprises a cylinder piston unit 2 having a cylinder housing 3 and a piston 4, 5 slidably guided within said cylinder housing 3 along an axial direction. The cylinder housing 3 is connected or connectable to the base B, as indicated in FIG. 1 by a corresponding arrow. The piston 4, 5 has a piston body 4 slidably supported in the cylinder housing 3 and a hollow piston rod 5 extending from the piston body 4 through and out of the cylinder housing 3 on one axial side. At its free end, the piston rod 5 is connected or connectable to the load L, as indicated in FIG. 1 by a corresponding arrow. The cylinder housing 3 is fixedly connected to a hollow axial inner piston tube 6 (also called a supporting shaft) which is open towards both axial sides. The piston rod 5 is slidably supported on an outer circumferential surface of the inner piston tube 6. Further, the piston rod 5 has a closed outer axial end surface.

In the cylinder piston unit 2, the piston 4, 5 separates a load-side pressure chamber 7 from a base-side pressure chamber 8. The load-side pressure chamber 7 is arranged on a side of the piston 4, 5 facing the load L. The piston rod 5 extends through the load-side pressure chamber 7, which is an annulus. An annulus surface, i.e. a surface of the piston body 4 surrounding the piston rod 5, forms a load-side piston pressure applying surface 9.

The base-side pressure chamber 8 is arranged on side of the piston 4, 5 facing the base B. The base-side pressure chamber 8 is accommodated inside the hollow inner piston tube 6 and the hollow piston rod 5. The closed outer axial end surface of the piston rod 5 forms a base-side piston pressure applying surface 10. The load-side piston pressure applying surface 9 is larger than the base-side piston pressure applying surface 10. A third chamber 11 (also called an idle compartment) is formed in the cylinder housing 3 on the side facing the base B and surrounding the inner piston tube 6. The third chamber 11 his connected to a low-pressure gas supply, particularly a nitrogen gas supply, via a connection portion 12 of the third chamber 11 or the idle compartment.

As illustrated via dashed lines in FIGS. 1 and 2, the (effective) base-side piston pressure applying surface 10 corresponds to a surface defined by subtracting a base-side ring-shaped surface area formed between the inner piston tube 6 and the piston rod 5 from a circular surface area of a load-side inner end surface of the piston rod 5.

The load-side pressure chamber 7 and the base-side pressure chamber 8 are connected with each other via a short circuiting line 13. The short circuiting line 13 includes a flow control device 14 in the form of a control valve, which can switch between an open state, wherein the load-side pressure chamber 7 and the base-side pressure chamber 8 are fluidically connected, and a closed state, wherein a flow of a working fluid between the load-side pressure chamber 7 and the base-side pressure chamber 8 is restricted, particularly prevented. Thus, via the short circuiting line 13 including the flow control device 14, the load-side pressure chamber 7 and the base-side pressure chamber 8 are selectively fluidically connectable.

A hydraulic displacement machine 15 is connected in parallel to the short circuiting line 13. Further, the hydraulic displacement machine 15 is fluidically connected to the load-side pressure chamber 7 and the base-side pressure chamber 8 in order to pump the working fluid between the load-side pressure chamber 7 and the base-side pressure chamber 8.

The hydraulic displacement machine 15 is driven by a driving unit, in particular an electric motor 16 according to the first embodiment, with adjustable torque and/or speed. A control unit 17 is adapted to control the electric motor 16, in particular supplying a variable amount of electric power form an electric power source 18 such as a battery to the electric motor 16. The control unit 17 is adapted to drive the electric motor 16 and the flow control device 14 based on operational parameters and/or sensor data. The operational parameters and sensor data may include information such as the weight and position of the load L, whether the load L is being lifted, lowered or held, an acceleration or motion of the base B or the like.

The hydraulic displacement machine 15, the flow control device 14 and the piston 4, 5 define a boundary between a load-side hydraulic circuitry and a base-side hydraulic circuitry. The load-side hydraulic circuitry connects the hydraulic displacement machine 15 and the flow control device 14 to the load-side pressure chamber 7. The base-side hydraulic circuitry connects the hydraulic displacement machine 15 and the flow control device 14 to the base-side pressure chamber 8. Preferably, the working fluid may flow essentially freely in the load-side hydraulic circuitry and the working fluid may flow essentially freely in the base-side hydraulic circuitry, whereas flow between the load-side hydraulic circuitry and the base-side hydraulic circuitry is selectively controlled by the flow control device 14 and the hydraulic displacement machine 15.

A hydraulic pressure storage device 19 is provided in the form of a hydraulic accumulator. The hydraulic accumulator has a working fluid chamber, which is fluidically connected to the load-side hydraulic circuitry. Additionally, the hydraulic accumulator has a gas chamber, which is compressible by the working fluid chamber to serve as a gas spring. Thus, the gas chamber is adapted to preload the working fluid chamber and to provide a predetermined pressure to at least the load-side hydraulic circuitry. The gas chamber may be connected to an accumulator gas storage 20 which may be used to adjust the predetermined pressure and/or to compensate leakage and the like.

The hydraulic stabilization device 1 may be operated in two different operational modes: a passive compensation mode and an active compensation mode, the latter being shown in FIG. 1.

In the passive compensation mode, the control unit 17 does not drive the hydraulic displacement machine 15 and controls the flow control device 14 to assume the open state, opening the short circuiting line 13. Then, working fluid can flow essentially freely between the load-side hydraulic circuitry and the base-side hydraulic circuitry. In consequence, a static pressure equilibrium will be set automatically, where a load-side pressure in the load-side pressure chamber 7, a base-side pressure in the base-side pressure chamber 8 and a storage pressure in the hydraulic storage device 19 will equalize, achieving a static equilibrium pressure. A position of the piston 4, 5 with respect to the cylinder housing 3 is determined by said static equilibrium pressure and a surface ratio of the load-side piston pressure applying surface 9 and the base-side piston pressure applying surface 10.

If the base B moves upwards, e.g. rising on a wave, the cylinder housing 3 is pulled upwards, extending the cylinder piston unit 2, so as to compensate the movement of the base B. Thus, in order to maintain a dynamic pressure equilibrium, the working fluid is pushed from the load-side pressure chamber 7 and flows into the base-side pressure chamber 8. However, the load-side piston pressure applying surface 9 is larger than the base-side piston-pressure applying surface 10. Therefore, more of the working fluid is being pushed out of the load-side pressure chamber 7 than flowing into the base-side pressure chamber 8. A remaining working fluid volume is pushed into the working fluid chamber of the hydraulic pressure storage device 19, compressing the gas inside the gas chamber. Accordingly, once the base B stops reverses its movement, said gas inside the gas chamber will expand again, returning the hydraulic stabilization device 1 to its static pressure equilibrium. Similarly, if the base B moves downwards, e.g. drops into a wave trough, the same process will occur in a reverse direction.

In the active compensation mode, the control unit 17 controls the flow control device 14 to assume the closed state, preventing or restricting a flow through the short circuiting line 13. Further, the control unit 17 drives the hydraulic displacement machine 15 to pump the working fluid from the load-side hydraulic circuitry to the base-side hydraulic circuitry or vice versa, in response to the motion of the sea, in order to retract or extend the cylinder piston unit 2 accordingly.

The hydraulic pressure storage device 19 maintains a spring-like behavior in the active compensation mode. That is, when the hydraulic displacement machine 15 pumps the working fluid from the load-side hydraulic circuitry into the base-side hydraulic circuitry, the cylinder piston unit 2 is extended. The working fluid is pushed out of the load-side pressure chamber 7 into the base-side pressure chamber 8 and into the hydraulic pressure storage device 19, compressing the gas inside its gas chamber and providing or increasing a preload acting on the load-side hydraulic circuitry. When a drive direction of the hydraulic displacement machine 15 is switched or a coupling between the electric motor 16 and the hydraulic displacement machine 15 is decoupled or the hydraulic displacement machine 15 and the electric motor 16 are switched into generator mode for energy regeneration, said preload retracts or contributes to retracting the cylinder piston unit 2 and, in the latter case, enables energy regeneration.

FIG. 2 shows a second embodiment, wherein instead of the electric motor 16, a secondary hydraulic drive 21 is provided as the driving unit for driving the hydraulic displacement machine 15. The secondary hydraulic drive 21 is connected or connectable to a passive working fluid volume. Said passive working fluid volume may e.g. be provided by the working fluid within the hydraulic pressure storage device 19. That is, the secondary hydraulic drive 21 may, on one side, be connected to the hydraulic pressure storage device 19 in a direct manner or in an indirect manner, e.g. via the load-side hydraulic circuitry. Otherwise, the second embodiment corresponds to the first embodiment shown in FIG. 1.

### LIST OF REFERENCE SIGNS

1 hydraulic stabilization device
2 cylinder piston unit
3 cylinder housing
4 piston body
5 piston rod
6 inner piston tube
7 load-side pressure chamber (passive rod-side compartment)
8 base-side pressure chamber (active bottom-side compartment)
9 (effective) load-side piston pressure applying surface
10 (effective) base-side piston pressure applying surface
11 third chamber (idle compartment)
12 connection portion of idle compartment
13 short circuiting line
14 flow control device (control valve)
15 hydraulic (fixed-) displacement machine (pump)
16 electric motor (driving unit)
17 control unit
18 electric power source (battery)
19 hydraulic pressure storage device (hydraulic accumulator)
20 accumulator gas storage
21 secondary hydraulic drive (driving unit)
B base
L load

1. A hydraulic stabilization device for stabilizing a load, which is suspended from a base on a defined height relative to a horizontal reference plane, the base having a variable height relative to the horizontal reference plane, the hydraulic stabilization device including a cylinder piston unit connected or connectable in a force transmission path between the base and the load and comprising a piston, which separates two pressure chambers having different piston pressure applying surfaces and acting in opposing directions with respect to each other, and a hydraulic pressure storage device, characterized by a short circuiting line adapted to selectively fluidically connect the two pressure chambers, wherein the hydraulic pressure storage device is fluidically connected to the short circuiting line, in order to extend and retract the cylinder piston unit in response to a dynamic height variance of the base and in an opposite direction of said dynamic height variance of the base, by providing a dynamic pressure equilibrium between the two pressure chambers, wherein the two pressure chambers include a load-side pressure chamber, which is arranged on a side of the piston facing towards the load and includes one of the piston pressure applying surfaces providing a load-side piston pressure applying surface, and a base-side pressure chamber, which is arranged on a side of the piston facing towards the base and includes another one of the piston pressure applying surfaces providing a base-side piston pressure applying surface, with the load-side piston pressure applying surface being larger than the base-side piston pressure applying surface.

2. The hydraulic stabilization device according to claim 1, further comprising a hydraulic displacement machine, particularly a two-way pump, being fluidically connected to at least one of the two pressure chambers and being adapted to supply a working fluid to the at least one of the two pressure chambers.

3. The hydraulic stabilization device according to claim 2, wherein the hydraulic displacement machine is, on another side, connected to the hydraulic pressure storage device, the hydraulic displacement machine being in particular arranged parallel to the short circuiting line.

4. The hydraulic stabilization device according to claim 2, further comprising a control unit adapted to control the hydraulic displacement machine and the short circuiting line such that, in a passive compensation mode, the short circuiting line fluidically connects the two pressure chambers, or in an active compensation mode, the short circuiting line fluidically disconnects the two pressure chambers and the hydraulic displacement machine is active.

5. The hydraulic stabilization device according to claim 4, wherein the control unit controls an electric motor driving the hydraulic displacement machine and the electric motor and the control unit are suitable for energy regeneration.

6. The hydraulic stabilization device according to claim 4, wherein the control unit controls at least one secondary hydraulic drive driving the hydraulic displacement machine, preferably adapted to receive and restore hydraulic power from, or respectively to, a passive working fluid volume, preferably the hydraulic pressure storage device.

7. The hydraulic stabilization device according to claim 1, wherein a pressure of the hydraulic pressure storage device is provided in accordance with the load and a ratio of the piston pressure applying surfaces with respect to each other.

8. The hydraulic stabilization device according to claim 1, wherein the piston includes a hollow piston rod accommodating one of the two pressure chambers.

9. The hydraulic stabilization device according to claim 1, wherein the short circuiting line includes a flow control device, preferably a control valve, adapted to selectively open or restrict, particularly prevent, a flow of the working fluid through the short circuiting line.
